(19) United States
(12) Patent Application Publication
(10) Pub. No.: US 2013/0198411 A1
(43) Pub. Date: Aug. 1, 2013

(54) PACKET PROCESSING APPARATUS AND METHOD FOR LOAD BALANCING OF MULTI-LAYERED PROTOCOLS

(71) Applicant: Bin-Yeong YOON, Daejeon-si (KR)

(72) Inventor: Bin-Yeong YOON, Daejeon-si (KR)

(73) Assignee: Electronics and Telecommunications Research Institute, Daejeon (KR)

(21) Appl. No.: 13/619,855

(22) Filed: Sep. 14, 2012

(30) Foreign Application Priority Data
Jan. 27, 2012 (KR) 10-2012-0008500

(51) Int. Cl. G06F 15/173

(52) U.S. Cl. 709/244

(57) ABSTRACT

There are provided a packet processing apparatus and method for enabling an interface server connected to an external interface to set up a list of multi-layered protocols for processing a received packet and to control all service servers to distributively process the loads of the multi-layered protocols. The packet processing apparatus includes: an interface server configured to set up, if a packet is received from an external node, an execution order of protocols with respect to the received packet, and to edit the packet such that the packet includes information about the execution order of the protocols; a plurality of service servers configured to process the packet according to the corresponding protocols in the execution order of the protocols; and a switch configured to transfer the packet between the interface server and the plurality of service servers.

### CROSS-REFERENCE TO RELATED APPLICATION

This application claims the benefit under 35 U.S.C. §119(a) of Korean Patent Application No. 10-2012-0008500, filed on Jan. 27, 2012, the entire disclosure of which is incorporated herein by reference for all purposes.

### BACKGROUND

1. Field

The following description relates to a protocol load balancer capable of efficiently processing premium services as well as processing packets.

2. Description of the Related Art

With development of network technologies, requirements for various services are increasing and the boundaries between communication protocol layers are getting blurred. Also, premium services in which several protocols are combined to process a single packet are increasing.

Load balancers developed so far cause a server to execute all protocols, or several servers to distributively execute protocols. In general, by differentiating the hardware or software of servers according to protocols it is possible to configure a dedicated server capable of optimally executing only a specific protocol. In the case of executing all protocols in a server, it is impossible to sufficiently utilize the characteristic of such a dedicated server. Meanwhile, in the case of distributively executing protocols in several servers, packets have to be processed through several servers in order to execute multi-layered protocols. In this case, the servers may overlappingly perform some functions, or the performance of packet processing deteriorates due to insufficient organic cooperation between the servers.

A conventional representative protocol load balancer is a L7 load balancer (or a server farm) that is used in security systems, data centers, etc. The conventional load balancer distributively processes received traffic in several servers. However, conventional studies have focused on load balancers capable of equally distributing allocated tasks in order to solve a problem of unbalanced loading of a plurality of processors or servers. A representative method for load balancing is to inspect the loads of servers and equally distribute the loads of the servers.

A conventional load balancer is disclosed in Korean Patent Application No. 10-2010-0014854, entitled “Apparatus for Balancing Load”, laid open on Aug. 24, 2011, and filed by Samsung Electronics Co., Ltd.

### SUMMARY

The following description relates to a packet processing apparatus and method for enabling an interface server connected to an external interface to set up a list of multi-layered protocols for processing a received packet and to control all service servers to distributively process the loads of the multi-layered protocols.

In one general aspect, there is provided a packet processing apparatus including: an interface server configured to set up, if a packet is received from an external node, an execution order of protocols with respect to the received packet, and to edit the packet such that the packet includes information about the execution order of the protocols; a plurality of service servers configured to process the packet according to the corresponding protocols in the execution order of the protocols; and a switch configured to transfer the packet between the interface server and the plurality of service servers.

In another general aspect, there is provided a packet processing method including: at an interface server, receiving a packet from an external node; at the interface server, setting up an execution order of protocols with respect to the received packet and editing the packet such that the packet includes information about the execution order of the protocols, thereby creating a first edited packet; at a switch, transferring the first edited packet to a first service server that is to first process the first edited packet according to the execution order of protocols; at the first service server, processing the first edited packet; at the first service server, determining whether the first edited packet has to be further processed according to a predetermined protocol that is provided by another service server; at the first servicer server, adding, if the edited packet has to be further processed according to a predetermined protocol that is provided by another service server, a packet processing result field containing a packet processing result of the first service server to the first edited packet to create a second edited packet, and transferring the second edited packet to the switch; and at the switch, transferring the second edited packet to a second service server that is to process the second edited packet according to the predetermined protocol.

Other features and aspects will be apparent from the following detailed description, the drawings, and the claims.

### BRIEF DESCRIPTION OF THE DRAWINGS

FIG. 1 is a diagram illustrating an example of a packet processing apparatus for executing multi-layered protocols and distributing the loads of the multi-layered protocols.

FIG. 2 shows examples of an ingress packet, an edited ingress packet, and an egress packet.

FIG. 3 is a flowchart illustrating an example of an operation method of an interface server.

FIG. 4 is a flowchart illustrating an example of an operation method of a service server.

FIG. 5 is a flowchart illustrating an example of an operation method of a packet processing apparatus.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

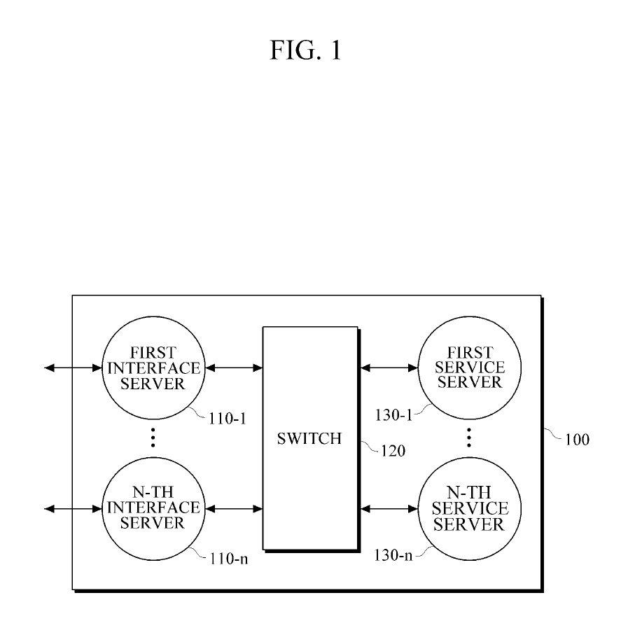

FIG. 1 is a diagram illustrating an example of a packet processing apparatus 100 for executing multi-layered protocols and distributing the loads of the multi-layered protocols.

Referring to FIG. 1, the packet processing apparatus 100 includes a plurality of interface servers 110-1 through 110-n, and a plurality of service servers 130-1 through 130-n. The packet processing apparatus 100 may be a network system over which the plurality of interface servers 110-1 through 110-n, a switch 120, and the plurality of service servers 130-1 through 130-n are distributed, or a single apparatus into which the plurality of interface servers 110-1 through 110-n, the switch 120, and the plurality of service servers 130-1 through 130-n are integrated.

The plurality of interface servers 110-1 through 110-n are connected to neighboring network nodes to receive/transmit packets from/to the network nodes.

The switch 120 transfers packets to their destination servers in the packet processing apparatus 100. The destination servers include the service servers 130-1 through 130-n for processing the packets according to predetermined protocols, and the interface servers 110-1 through 110-n for outputting packets processed according to the predetermined protocols to the outside.

The plurality of service servers 130-1 through 130-n process received packets according to predetermined communication protocols, respectively. Each service server may be a dedicated server for a specific protocol. The dedicated service server for the specific protocol may be a single server or configured with a plurality of servers.

For convenience, the following description will be given in relation to the first interface server 110-1 and the n-th service server 130-n.

If the first service server 110-1 receives a packet from an external node, the first service server 110-1 sets up an execution order of protocols according to which the packet has to be processed, and then edits the packet such that the packet includes information about the execution order of protocols. The packet received from the external node is referred to as an ingress packet. After the execution order of protocols is set up, service servers for executing the protocols may be designated from among the plurality of service servers 130-1 through 130-n.

For example, when several service servers have to cooperate to detect a specific virus, the first interface server 110-1 may designate one or more service servers (for example, the first service server 130-1 and the n-th service server 130-n) for executing protocols capable of detecting the pattern of the specific virus.

The designated service servers 130-1 and 130-n receive a packet including information about an execution order of the protocols, and process the packet according to the corresponding protocols. That is, the packet is sequentially input to the service servers 130-1 and 130-n designated in the execution order of the protocols, and processed according to the protocols that are provided by the service servers 130-1 and 130-n.

The packet processed by the service servers 130-1 and 130-n is output to the first interface server 110-1 that has received the packet, or to another interface server (for example, the interface server 110-n), according to the packet's destination.

Such a central control type of packet processing prevents service servers from overlappingly performing the same operation by processing packets in consideration of the previous processing results. Also, by setting up an execution order of protocols based on the hierarchical relationship between communication protocols, it is possible to achieve efficient processing of packets. That is, by classifying communication protocols into layers of L1 through L7 and allowing a user to set up an execution order of protocols based on the hierarchical relationship between the layers L1 through 7 it is possible to efficiently process packets.

The first interface server 110-1 distinguishes an ingress packet received from an external node from an egress packet received from the switch 120, and separately processes them.

The first interface server 110-1 may decide a protocol(s) to process a received ingress packet, edit the ingress packet such that the ingress packet includes the identifier (ID) of a service server capable of executing the decided protocol, and transfer the edited ingress packet to the switch 120. If a plurality of protocols is required to process the received ingress packet, the first interface server 110-1 may edit the ingress packet such that the ingress packet includes the IDs of a plurality of service servers capable of executing the corresponding protocols according to an execution order of the protocols, and transfer the edited ingress packet to the switch 120.

The first interface server 110-1 may decide at least one protocol to process a received ingress packet, with reference to a protocol list table in which the service servers 130-1 through 130-n are mapped to protocols that can be respectively executed by the service servers 130-1 through 130-n. The protocol list table may be stored in each of the interface servers 110-1 through 110-n. Or, the protocol list table may be stored in a predetermined storage included in the packet processing apparatus 100 and shared by all the interface servers 110-1 through 110-n.

The first interface server 110-1 may create a flow for a received ingress packet, and allocate the same execution order of protocols to the flow.

Meanwhile, if it receives an egress packet from the switch 120, the first interface server 110-1 may process the egress packet based on the packet processing result of an interface server and the packet processing results of a service server(s) included in the egress packet, and transmit the processed packet to an external node.

It is assumed that the n-th service server 130-n has received a packet processed by the first service server 130-1 that has received the packet from the first interface server 110-1.

The n-th service server 130-n analyzes the received packet and processes the packet based on a field containing the packet processing result of the first interface server 110-1 and fields containing the packet processing results of other service servers. The n-th service server 130-n may determine whether the received packet has to be further processed according to a predetermined protocol that is provided by another service server.

The n-th service server 130-n may determine whether the received packet includes another service server ID field after the server ID field of the n-th service server 130-n, thereby determining whether the packet has to be further processed according to a predetermined protocol that is provided by another service server. If the packet has to be further processed according to a predetermined protocol that is provided by another service server, the n-th service server 130-n may edit the packet such that the packet includes a field containing the packet processing result of the n-th service server 130-n, and transfer the edited packet to the corresponding service server that will process the packet according to the predetermined protocol.

Meanwhile, if the packet does not need to be processed according to any protocol that is provided by another service server, the n-th service server 130-n may edit the packet such that the packet includes a field containing the packet processing result of the n-th service server 130-n, and transfer the edited packet to the switch 120 so that the packet is transferred to an interface server that will output the packet.

According to the packet processing apparatus 100, since when a received packet is required to be processed according to a plurality of protocols, an execution order of the protocols is set up in consideration of the hierarchical relationship between the protocols, the packet is processed according to the execution order of the protocols, and the processing results are sequentially shared between service servers, it is possible to prevent the same protocol from being overlappingly executed with respect to a packet, which leads to efficient processing of packets according to multi-layered protocols.

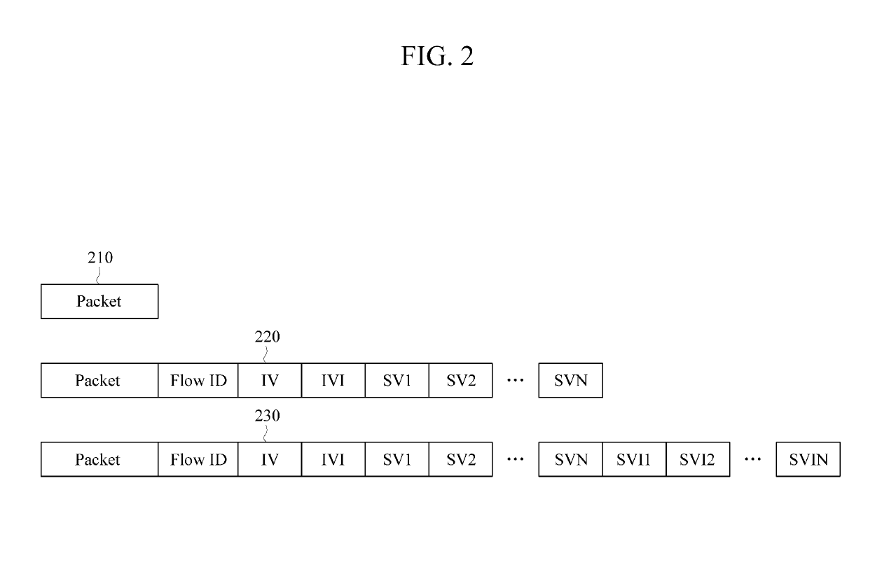

FIG. 2 shows examples of an ingress packet 210, an edited ingress packet 220, and an egress packet 230. The following description will be given with reference to FIGS. 1 and 2.

The ingress packet 210 represents a packet transmitted to an interface server from an external node. Hereinafter, it is assumed that the ingress packet 210 has been received by the first interface server 110-1.

The edited ingress packet 220 is obtained by processing the ingress packet 210 in the first interface server 110-1 and output to the switch 120. The edited ingress packet 220 includes a flow ID field Flow ID, an interface server ID field IV containing the ID of the first interface server 110-1 that has received the ingress packet 210 and the ID of an interface server that will output the edited ingress packet 220, a packet processing result field IVI containing the processing result of the ingress packet 210 by the first interface server 110-1, and service server ID fields SV1, . . . , SVN containing the IDs of service servers to which the edited ingress packet 220 has to be transferred.

An interface server that has received a packet may be identical to or different from an interface server that will output the packet. If an interface server that has received a packet is different from an interface server that will output the packet, the interface server ID field IV may be segmented into two fields to separately store the ID of an input interface server and the ID of an output interface server. For example, if a certain packet is received by the first interface server 110-1 and output by the n-th interface server 110-n, the interface server ID field IV may contain the ID of the first interface server 110-1 and the ID of the n-th interface server 110-n.

The packet processing result field IVI containing the packet processing result of the first interface server 110-1 may be used by another service server or interface server processing the packet. For example, the packet processing result of the first interface server 110-1 may be statistical information about packets, that is, how many packets are received with respect to the flow to which the corresponding packet belongs, etc. However, the packet processing result is not limited to this, and may include various kinds of information.

The fields of the edited ingress packet 220 may be arranged in various ways so long as the interface servers and service servers in the packet processing apparatus 100 can recognize the fields. However, the arrangement order of the service server ID fields SV1, . . . , SVN included in the edited ingress packet 220 has to be maintained. That is, the service server ID fields have to be arranged necessarily in the order of service servers to which the corresponding packet has to be sequentially transferred. Herein, for convenience of description, the service server ID fields are arranged in the order of SV1, SV2, . . . , SVN. However, the service server ID fields may be arranged in a different order, such as SVN→SV1→SV2. Each service server processes the received packet and then transfers the processed packet to the next service server.

The egress packet 230 is received from the switch 120 and includes the results of processing by the corresponding service servers. The egress packet 230 is assumed to be a packet that is obtained by processing a packet received by the first interface server 110-1 in the n-th service server 130-1 and will be transferred to the first interface server 110-1 which is a destination interface server.

The egress packet 230 that is transferred from the switch 120 to the first interface server 110-1 includes a flow ID field Flow ID, an interface server ID field IV containing the ID of the first interface server 110-1 (that is, referred to as an input interface server) that has received the corresponding ingress packet (to drafter: ok?) and the ID of the first interface server 110-1 (referred to as an output interface server) that will output the egress packet 230, a packet processing result field IVI containing the packet processing result of the input interface server 110-1, service server ID fields containing the IDs of service servers SV1, . . . , SVN through which the corresponding packet has been transferred, and packet processing result fields containing packet processing results SVI1, SVI2, . . . , SVIN created by the individual service servers. The fields may be arranged in a different way. The packet processing result SVIN created by the n-th service server 130-n may include information on whether a specific virus pattern was found.

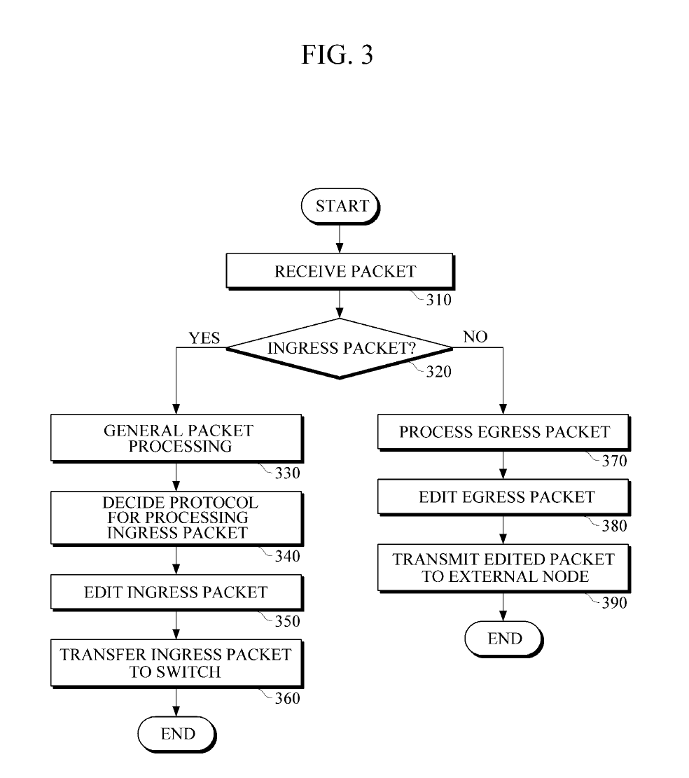

FIG. 3 is a flowchart illustrating an example of an operation method of an interface server. The following description will be given with reference to FIGS. 1 and 3.

For convenience of description, the first interface server 110-1 among the plurality of interface servers 110-1 through 110-n has received a packet.

Referring to FIGS. 1 and 3, the first interface server 110-1 receives a packet (310).

Then, it is determined whether the received packet is an ingress packet (320). If the received packet is an ingress packet, the first interface server 110-1 performs general packet processing (330). In detail, the first interface server 110-1 processes the packet according to protocols belonging to L2 to L3 layers, decides a next destination node (that is, an output interface server) to which the packet will be transferred, and then creates a flow. The first interface server 110-1 may create a flow for distinguishing packets, using information included in L2 to L4 packet headers. Packets having the same flow ID pass through the same service servers and are processed in the same way.

Successively, the first interface server 110-1 decides a protocol for processing the ingress packet (340). If it is requested that the ingress packet be processed according to a plurality of protocols, the first interface server 110-1 may set up an execution order of protocols, as follows.

The first interface server 110-1 may classify the protocols according to the hierarchical relation between the protocols, and set up an execution order of the protocols such that protocols belonging to a lower layer are executed earlier and protocols belonging to a higher layer are executed later. The protocols belonging to the higher layer, for example, include processing to detect a specific pattern (for example, a virus pattern) in a payload. Or, when a plurality of protocols belonging to the same layer have to be executed, the first interface server 110-1 may set up an execution order of the protocols in consideration of the hierarchical relationship between the protocols.

The first interface server 110-1 stores a protocol list table in which the service servers 130-1 through 130-n are mapped to protocols that can be respectively executed by the service servers 130-1 through 130-n. The first interface server 110-1 decides an order of service servers through which the packet has to pass according to the execution order of the protocols, with reference to the protocol list table. The protocol list table may be configured to include information about protocol processing services that are provided by the individual service servers, in such a way that the second service server 130-2 is mapped to a virus check service and the third service server 130-3 is mapped to a web service providing service.

The first interface server 110-1 edits the ingress packet (350). The first interface server 110-1 may edit the ingress packet such that the ingress packet includes the IDs of service servers capable of executing the decided protocols. If the ingress packet is required to be processed according to a plurality of protocols, the first interface server 110-1 may edit the ingress packet such that the ingress packet includes the IDs of a plurality of service servers capable of executing the decided protocols.

The edited ingress packet includes a flow ID field, an interface server ID field including the ID of an interface server that has received the corresponding ingress packet and the ID of an interface server that will output the edited ingress packet, a packet processing result field containing the packet processing result of the first interface server 110-1, and service server ID fields containing the IDs of service servers to which the edited ingress packet will be transferred. The service server ID fields have to be arranged in the exact order of service servers to which the packet has to be sequentially transferred, so that each service server can process a received packet and transfer the processed packet to the next service server. The packet processing result field containing the packet processing result of the first interface server 110-1 may include packet processing information that is used by another service server or interface server.

The first interface server 110-1 transfers the processed ingress packet to the switch 120 (360). The switch 120 may transfer the edited ingress packet to a service server identified by a service server ID included in the first service server field.

Meanwhile, if it is determined in operation 320 that the received packet is an egress packet, the first interface server 110-1 identifies the egress packet according to its flow ID, and processes the egress packet based on a packet processing result field corresponding to an input interface server and packet processing result fields corresponding to service servers (370).

In detail, the first interface server 110-1 removes additional information used in the packet processing apparatus 100 to thereby edit the egress packet into an appropriate format (for example, the original ingress packet 210) that can be identified by an external node (380). For example, if the external node is an Ethernet switch, the first interface server 110-1 may change the format of the egress packet to an Ethernet frame format.

The first interface server 110-1 transmits the edited packet to the external node (390).

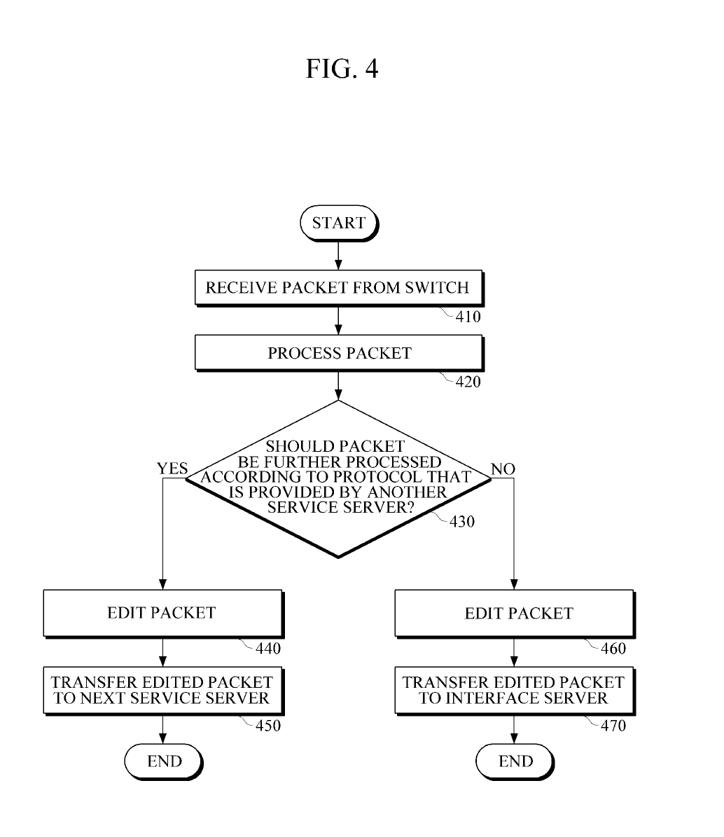

FIG. 4 is a flowchart illustrating an example of an operation method of a service server. The following description will be given with reference to FIGS. 1 and 4.

In the example of FIG. 4, it is assumed that the n-th service server 130-n among the plurality of service servers 130-1 through 130-N has received a packet.

The n-th service server 130-n may receive two types of packets from the switch 120 (410). If the n-th service server 130-n receives the packet from an interface server, the packet has an edited ingress packet format as denoted by a reference numeral 220 in FIG. 2. Meanwhile, if the n-th service server 130-n receives the packet from another service server, the packet has an egress packet format as denoted by a reference numeral 230 in FIG. 2.

Then, the n-th service server 130-n analyzes the received packet and processes the packet according to a predetermined protocol that is provided by the n-th service server 130-n (420). In detail, the n-th service server 130-n identifies the packet using the flow ID of the packet. Then, the n-th service server 130-n checks its own ID from the service server ID fields (SV fields) of the packets to thereby determine whether the packet has been transferred to the n-th service server 130-n correctly according to an execution order of protocols.

Then, the n-th service server 130-n may process the packet using the packet processing result field corresponding to an input interface server, or using packet processing result fields corresponding to other service servers that have previously processed the packet, together with the packet processing result field corresponding to the input interface server.

The n-th service server 130-n decides a next service server to which the packet will be transferred, thereby determining whether the packet has to be further processed according to a predetermined protocol that is provided by another service server (430). The service server ID fields of a packet transferred from an input interface server include the IDs of all service servers to which the packet has to be transferred, wherein the service server ID fields are arranged in the transfer order of the packet. Accordingly, the n-th service server 130-n determines whether there is another service server ID field after its own service server ID field, thereby determining whether the packet has to be further processed according to a protocol that is provided by another service server.

If there is another service server ID field after its own service server ID field, the n-th service server 130-n reads information of the corresponding service server ID field and decides a next service server to which the packet will be transferred. Then, the n-th service server 130-n creates a packet processing result field SVIN, and inserts the packet processing result created in operation 420 into the resultant packet, thereby editing the packet (440).

The n-th service server 130-n transfers the edited packet to the next service server through the switch 120 (450).

Meanwhile, if it is determined in operation 430 that there is no service server ID field after its own service ID field, this means that the packet has been completely processed in the packet processing apparatus 100. Therefore, the n-th service server 130-n may determine that the packet has to be transferred to a destination interface server whose ID is included in the interface server field IV (see FIG. 2) of the packet.

Then, the n-th service server 130-n creates a packet processing result field SVIN, inserts the packet processing result created in operation 420 into the resultant packet, and edits the packet such that the packet can be recognized by the switch 120 (460). For example, switches may require different packet formats according to their types. If the switch 120 is an Ethernet switch, Ethernet frame processing is performed on the packet. That is, the packet may be edited to have a format suitable for a specific switch.

The n-th service server 130-n transfers the packet to a destination interface server (that is, an output interface server) through the switch 120 (470).

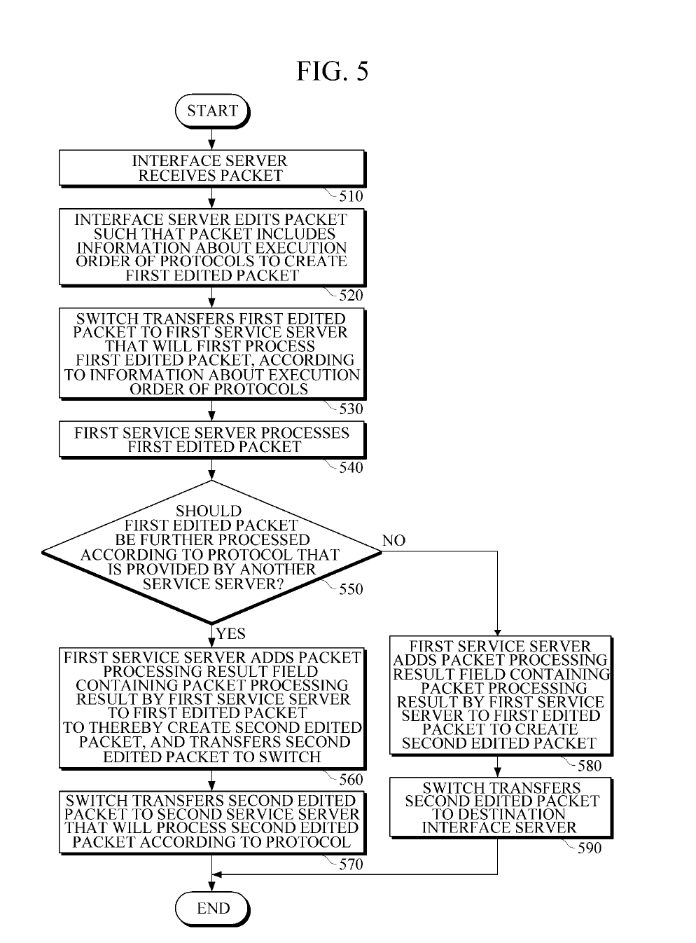

FIG. 5 is a flowchart illustrating an example of an operation method of the packet processing apparatus 100. The following description will be given with reference to FIGS. 1 and 5.

In the example of FIG. 5, it is assumed that the first interface server 110-1 receives a packet.

Referring to FIGS. 1 and 5, the first interface server 110-1 receives a packet from an external node (510).

Then, the first interface server 110-1 sets up an execution order of protocols with respect to the received packet, and edits the packet such that the packet includes information about the execution order of protocols, thereby creating a first edited packet (520).

The information about the execution order of protocols may be, when a received ingress packet is required to be processed according to a plurality of protocols, the IDs of a plurality of service servers that will process the packet sequentially according to an execution order of the protocols. The first edited packet may include a flow ID field, an input interface server ID field containing the ID of an input interface server (that is, the first interface server 110-1), an output interface server ID field containing the ID of an output interface server, a packet processing result field containing the packet processing result of the first interface server 110-1, and service server ID fields containing the IDs of service servers to which the packet has to be transferred.

The switch 120 transfers the first edited packet to a first service server 130-1 that will first process the first edited packet, according to the information about the execution order of protocols (530).

Then, the first service server 130-1 processes the first edited packet according to a protocol that is provided by the first service server (540). Then, the first service server 130-1 determines whether the first edited packet has to be further processed according to a predetermined protocol that is provided by another service server (550). The first service server 130-1 determines whether there is another service server ID field after its own service server ID field, thereby determining whether the packet has to be further processed according to a protocol that is provided by another service server.

If there is another service server ID field after its own service server ID field, the first service server 130-1 adds a packet processing result field containing the packet processing result of the first service server 130-1 to the first edited packet to thereby create a second edited packet, and transfers the second edited packet to the switch 120 (560).

The switch 120 transfers the second edited packet to a second service server that will process the second edited packet according to the predetermined protocol (570).

The second service server may analyze the received packet, process the packet based on information of the packet processing result field corresponding to the input interface server and information of the packet processing result field corresponding to the first service server 130-1, included in the received packet, and determine whether the packet has to be further processed according to a predetermined protocol that is provided by another service server.

Meanwhile, if the packet does not need to be processed according to a protocol that is provided by another service server, the first service server adds a packet processing result field to the first edited packet to thereby create a second edited packet (580), and transfers the second edited packet to the switch 120. The switch 120 transfers the second edited packet to a destination interface server that will output the second edited packet (590).

Therefore, according to the current examples described above, if the packet processing apparatus receives a packet that is required to be processed according to a plurality of protocols, the packet processing apparatus sets up an execution order of the protocols in consideration of the hierarchical relationship between the protocols, and processes the packet according to the execution order of the protocols. Also, since the protocol execution results with respect to packets are sequentially shared by all service servers, it is possible to prevent the service servers from overlappingly executing the same protocol, which leads to efficient execution of multi-layered protocols.

The present invention can be implemented as computer-readable code in a computer-readable recording medium. The computer-readable recording medium includes all types of recording media in which computer-readable data are stored. Examples of the computer-readable recording medium include a ROM, a RAM, a CD-ROM, a magnetic tape, a floppy disk, and an optical data storage. Further, the recording medium may be implemented in the form of carrier waves such as used in Internet transmission. In addition, the computer-readable recording medium may be distributed to computer systems over a network, in which computer-readable code may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A packet processing apparatus comprising:
an interface server configured to set up, if a packet is received from an external node, an execution order of protocols with respect to the received packet, and to edit the packet such that the packet includes information about the execution order of the protocols;
a plurality of service servers configured to process the packet according to the corresponding protocols in the execution order of the protocols; and
a switch configured to transfer the packet between the interface server and the plurality of service servers.

2. The packet processing apparatus of claim 1, wherein the interface server decides a protocol according to which the received packet has to be processed, edits the received packet such that the packet includes an identifier (ID) of a service server that executes the protocol, and transfers the edited packet to the switch.

3. The packet processing apparatus of claim 2, wherein if the received packet is required to be processed according to a plurality of protocols, the interface server edits the packet such that the packet includes information about IDs of a plurality of service servers that process the packet according to the corresponding protocols in an execution order of the protocols, the IDs of the service servers arranged in the execution order of the protocols that are respectively executed by the service servers, and transfers the edited packet to the switch.

4. The packet processing apparatus of claim 1, wherein the interface server decides at least one protocol that is to process the received packet with reference to a protocol list table in which the service servers are mapped to protocols that are respectively executed by the service servers.

5. The packet processing apparatus of claim 2, wherein the edited packet includes a flow ID field, a packet processing result field containing a processing result of the packet by the interface server, an interface server ID field containing an ID of the interface server through which the packet is input and output, and at least one service server ID field containing an ID of at least one service server to which the packet has to be transferred.

6. The packet processing apparatus of claim 1, wherein if the received packet is an egress packet received from the switch, the interface server processes the egress packet based on information of a packet processing result field corresponding to an input interface server and information of a packet processing result field corresponding to a service server included in the egress packet, and transmits the processed egress packet to an external node.

7. The packet processing apparatus of claim 1, wherein the interface server creates a flow for the received packet, and allocates the same execution order of protocols to the flow.

8. The packet processing apparatus of claim 1, wherein an n-th service server among the plurality of service servers analyzes a received packet, processes the packet based on information of a packet processing result field corresponding to an input interface server and information of packet processing result fields corresponding to other service servers that have previously processed the packet included in the received packet, and determines whether the packet has to be further processed according to a predetermined protocol that is provided by another service server.

9. The packet processing apparatus of claim 8, wherein the n-th service server determines whether there is another service server ID field after a service server ID field of the n-th service server, thereby determining whether the packet has to be further processed according to a predetermined protocol that is provided by another service server.

10. The packet processing apparatus of claim 8, wherein if the packet has to be further processed according to a predetermined protocol that is provided by another service server, the n-th service server edits the packet such that the packet includes a packet processing result field containing a packet processing result of the n-th service server, and transfers the edited packet to the switch so that the edited packet is transferred to the service server that is to process the packet according to the predetermined protocol.

11. The packet processing apparatus of claim 8, wherein if the packet does not need to be processed according to any protocol that is provided by another service server, the n-th service server edits the packet such that the packet includes a packet processing field containing a packet processing result of the n-th service server, and transfer the edited packet to the switch so that the edited packet is transferred to an interface server that is to output the packet.

12. A packet processing method comprising:
at an interface server, receiving a packet from an external node;
at the interface server, setting up an execution order of protocols with respect to the received packet and editing the packet such that the packet includes information about the execution order of the protocols, thereby creating a first edited packet;
at a switch, transferring the first edited packet to a first service server that is to first process the first edited packet according to the execution order of protocols;
at the first service server, processing the first edited packet;
at the first service server, determining whether the first edited packet has to be further processed according to a predetermined protocol that is provided by another service server;
at the first servicer server, adding, if the edited packet has to be further processed according to a predetermined protocol that is provided by another service server, a packet processing result field containing a packet processing result of the first service server to the first edited packet to create a second edited packet, and transferring the second edited packet to the switch; and
at the switch, transferring the second edited packet to a second service server that is to process the second edited packet according to the predetermined protocol.

13. The packet processing method of claim 12, further comprising:
at the second service server, analyzing a received packet, and processing the packet based on information of a packet processing result field corresponding to an input interface server and information of the packet processing result field corresponding to the first service server included in the received packet; and
at the second service server, determining whether the packet has to be further processed according to a predetermined protocol that is provided by another service server.

14. The packet processing method of claim 12, further comprising:
at the first service server, editing, if the first edited packet does not need to be processed according to any protocol that is provided by another service server, the first edited packet such that the first edited packet includes a packet processing field containing a packet processing result of the first service server, to create a second edited packet, and transferring the second edited packet to the switch; and
at the switch, transferring the second edited packet to a destination interface server that is to output the second edited packet.

15. The packet processing method of claim 12, wherein if the received packet is required to be processed according to a plurality of protocols, information about the execution order of protocols with respect to the received packet is information about IDs of a plurality of service servers that process the packet according to the corresponding protocols in the execution order of the protocols, the IDs of the service servers arranged in the execution order of the protocols that are respectively executed by the service servers.

16. The packet processing method of claim 12, wherein the first edited packet includes a flow ID field, a packet processing result field containing a processing result of the packet by the interface server, an interface server ID field containing an ID of the interface server through which the packet is input and output, and at least one service server ID field containing an ID of at least one service server to which the packet has to be transferred.

17. The packet processing method of claim 16, wherein the first service server determines whether the first edited packet includes another service server ID field after a service server ID field corresponding to the first service server, thereby determining whether the first edited packet has to be further processed according to a predetermined protocol that is provided by another service server.

18. The packet processing method of claim 12, wherein the interface server further comprises:
processing, if an egress packet is received from the switch, the egress packet based on information of a packet processing result field corresponding to an input interface server and information of a packet processing result field corresponding to a service server included in the egress packet; and
transmitting the processed egress packet to an external node.
